(19) United States
(12) Patent Application Publication
(10) Pub. No.: US 2024/0054670 A1
(43) Pub. Date: Feb. 15, 2024

(54) Image-Assisted Segmentation of Object Surface for Mobile Dimensioning

(71) Applicant: ZEBRA TECHNOLOGIES CORPORATION, Lincolnshire, IL (US)

(72) Inventors: Michael Wijayantha Medagama, Nawala (LK); Raveen T. Thrimawithana, Pannipitiya (LK); Rochana Pathiraja, Dampelessa (LK); Sanduni Karunatilaka, Kottawa (LK)

(21) Appl. No.: 18/227,701

(22) Filed: Jul. 28, 2023

Related U.S. Application Data
(60) Provisional application No. 63/397,975, filed on Aug. 15, 2022.

(51) Int. Cl. G06T 7/60; G06T 17/00; G06T 7/194; G06V 10/60; G06V 20/70

(52) U.S. Cl. CPC G06T 7/60; G06T 17/00; G06T 7/194; G06V 10/60; G06V 20/70

(57) ABSTRACT

A method in a computing device includes: capturing, via a depth sensor, (i) a point cloud depicting an object resting on a support surface, and (ii) a two-dimensional image depicting the object and the support surface; detecting, from the point cloud, the support surface and a portion of an upper surface of the object; labelling a first region of the image corresponding to the portion of the upper surface as a foreground region; based on the first region, performing a foreground segmentation operation on the image to segment the upper surface of the object from the image; determining, based on the point cloud, a three-dimensional position of the upper surface segmented from the image; and determining dimensions of the object based on the three-dimensional position of the upper surface.

### CROSS-REFERENCE TO RELATED APPLICATIONS

This application claims priority from U.S. provisional application No. 63/397,975, filed Aug. 15, 2022, the contents of which is incorporated herein by reference.

### BACKGROUND

Depth sensors such as time-of-flight (ToF) sensors can be deployed in mobile devices such as handheld computers, and employed to capture point clouds of objects (e.g., boxes or other packages), from which object dimensions can be derived. Point clouds generated by ToF sensors, however, may incompletely capture surfaces of the objects, and/or include artifacts caused by multipath reflections received at the sensor.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device for dimensioning an object.

FIG. 2 is a diagram of an example point cloud captured by the device of FIG. 1.

FIG. 3 is a diagram illustrating multipath artifacts in depth data captured by the mobile computing device of FIG. 1.

FIG. 4 is a flowchart of a method of image-assisted surface segmentation for mobile dimensioning.

FIG. 5 is a diagram illustrating a performance of block 405 of the method of FIG. 4.

FIG. 6 is a diagram illustrating an example performance of blocks 410 and 415 of the method of FIG. 4.

FIG. 7 is a diagram illustrating a example performance of blocks 420 and 425 of the method of FIG. 4.

FIG. 8 is a flowchart of a method of assessing a point cloud for multipath artifacts at block 435 of the method of FIG. 4.

FIG. 9 is a diagram illustrating a example performance of blocks 805 to 815 of the method of FIG. 8.

FIG. 10 is a diagram illustrating a example performance of block 820 of the method of FIG. 8.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device, the method comprising: capturing, via a depth sensor, (i) a point cloud depicting an object resting on a support surface, and (ii) a two-dimensional image depicting the object and the support surface; detecting, from the point cloud, the support surface and a portion of an upper surface of the object; labelling a first region of the image corresponding to the portion of the upper surface as a foreground region; based on the first region, performing a foreground segmentation operation on the image to segment the upper surface of the object from the image; determining, based on the point cloud, a three-dimensional position of the upper surface segmented from the image; and determining dimensions of the object based on the three-dimensional position of the upper surface.

In some examples, the method further comprises presenting the dimensions on a display of the computing device.

In some examples, the method further comprises labelling a second region of the image corresponding to the support surface as a background region.

In some examples, the method further comprises: detecting, in the point cloud, a further surface distinct from the upper surface and the support surface; and labelling a third region of the image corresponding to the further surface as a probably background region.

In some examples, detecting the further surface includes detecting a portion of the point cloud with a normal vector different from a normal vector of the upper surface by at least a threshold.

In some examples, the method further comprises: labelling a remainder of the image as a probable foreground region.

In some examples, the method further comprises: prior to determining dimensions of the object, determining whether the point cloud exhibits multipath artifacts by: selecting a candidate point on the upper surface; determining a reflection score for the candidate point; and comparing the reflection score to a threshold.

In some examples, selecting the candidate point includes identifying a non-planar region of the upper surface, and selecting the candidate point from the non-planar region.

In some examples, determining a reflection score includes: for each of a plurality of rays originating at the candidate point, determining whether the point cloud contains a contributing point intersected by the ray; for each contributing point, determining an angle between the depth sensor, the contributing point, and the candidate point; and when a normal of the contributing point bisects the angle, incrementing the reflection score.

In some examples, determining a reflection score includes incrementing the reflection score based proportionally to a cosine of the angle.

Additional examples disclosed herein are directed to a computing device, comprising: a depth sensor; and a processor configured to: capture, via the depth sensor, (i) a point cloud depicting an object resting on a support surface, and (ii) a two-dimensional image depicting the object and the support surface; detect, from the point cloud, the support surface and a portion of an upper surface of the object; label a first region of the image corresponding to the portion of the upper surface as a foreground region; based on the first region, perform a foreground segmentation operation on the image to segment the upper surface of the object from the image; determine, based on the point cloud, a three-dimensional position of the upper surface segmented from the image; and determine dimensions of the object based on the three-dimensional position of the upper surface.

In some examples, the processor is further configured to present the dimensions on a display.

In some examples, the processor is further configured to: label a second region of the image corresponding to the support surface as a background region.

In some examples, the processor is further configured to: detect, in the point cloud, a further surface distinct from the upper surface and the support surface; and label a third region of the image corresponding to the further surface as a probably background region.

In some examples, the processor is further configured to detect the further surface by: detecting a portion of the point cloud with a normal vector different from a normal vector of the upper surface by at least a threshold.

In some examples, the processor is further configured to: label a remainder of the image as a probable foreground region.

In some examples, the processor is further configured to: prior to determining dimensions of the object, determine whether the point cloud exhibits multipath artifacts by: selecting a candidate point on the upper surface; determining a reflection score for the candidate point; and comparing the reflection score to a threshold.

In some examples, the processor is further configured to select the candidate point by identifying a non-planar region of the upper surface, and selecting the candidate point from the non-planar region.

In some examples, the processor is further configured to determine a reflection score by: for each of a plurality of rays originating at the candidate point, determining whether the point cloud contains a contributing point intersected by the ray; for each contributing point, determining an angle between the depth sensor, the contributing point, and the candidate point; and when a normal of the contributing point bisects the angle, incrementing the reflection score.

In some examples, the processor is further configured to determine a reflection score by incrementing the reflection score based proportionally to a cosine of the angle.

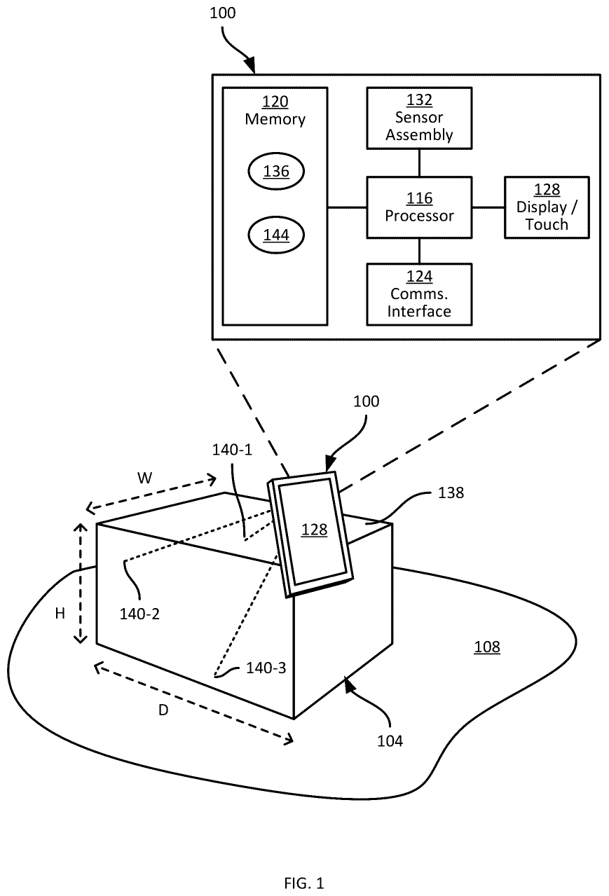

FIG. 1 illustrates a computing device 100 configured to capture sensor data depicting a target object 104 within a field of view (FOV) of a sensor of the device 100. The computing device 100, in the illustrated example, is a mobile computing device such as a tablet computer, smartphone, or the like. The computing device 100 can be manipulated by an operator thereof to place the target object 104 within the FOV of the sensor, in order to capture sensor data for subsequent processing as described below. In other examples, the computing device 100 can be implemented as a fixed computing device, e.g., mounted adjacent to an area in which target objects 104 are placed and/or transported (e.g., a staging area, a conveyor belt, a storage container, or the like).

The target object 104, in this example, is a parcel (e.g., a cardboard box or other substantially cuboid object), although a wide variety of other target objects can also be processed as set out below. The sensor data captured by the computing device 100 includes a point cloud. The point cloud includes a plurality of depth measurements (also referred to as points) defining three-dimensional positions of corresponding points on the target object 104. The sensor data captured by the computing device 100 also includes a two-dimensional image depicting the target object 104. The image can include a two-dimensional array of pixels, each pixel containing a color and/or brightness value. For instance, the image can be an infrared or near-infrared image, in which each pixel in the array contains a brightness or intensity value. From the captured sensor data, the device 100 (or in some examples, another computing device such as a server, configured to obtain the sensor data from the device 100) is configured to determine dimensions of the target object 104, such as a width “W”, a depth “D”, and a height “H” of the target object 104.

The target object 104 is, in the examples discussed below, a substantially rectangular prism. As shown in FIG. 1, the height H of the object 104 is a dimension substantially perpendicular to a support surface (e.g., a floor) 108 on which the object 104 rests. The width W and depth D of the object 104, in this example, are substantially orthogonal to one another and to the height H. The dimensions determined from the captured data can be employed in a wide variety of downstream processes, such as optimizing loading arrangements for storage containers, pricing for transportation services based on parcel size, and the like.

Certain internal components of the device 100 are also shown in FIG. 1. For example, the device 100 includes a processor 116 (e.g., a central processing unit (CPU), graphics processing unit (GPU), and/or other suitable control circuitry, microcontroller, or the like). The processor 116 is interconnected with a non-transitory computer readable storage medium, such as a memory 120. The memory 120 includes a combination of volatile memory (e.g. Random Access Memory or RAM) and non-volatile memory (e.g. read only memory or ROM, Electrically Erasable Programmable Read Only Memory or EEPROM, flash memory). The memory 120 can store computer-readable instructions, execution of which by the processor 116 configures the processor 116 to perform various functions in conjunction with certain other components of the device 100. The device 100 can also include a communications interface 124 enabling the device 100 to exchange data with other computing devices, e.g. via various networks, short-range communications links, and the like.

The device 100 can also include one or more input and output devices, such as a display 128, e.g., with an integrated touch screen. In other examples, the input/output devices can include any suitable combination of microphones, speakers, keypads, data capture triggers, or the like.

The device 100 further includes a sensor assembly 132 (also referred to herein as a sensor 132), controllable by the processor 116 to capture point cloud and image data. The sensor assembly 132 can include a sensor capable of capturing both depth data (that is, three-dimensional measurements) and image data (that is, two-dimensional measurements). For example, the sensor 132 can include a time-of-flight (ToF) sensor. The sensor 132 can be mounted on a housing of the device 100, for example on a back of the housing (opposite the display 128, as shown in FIG. 1) and having an optical axis that is substantially perpendicular to the display 128.

A ToF sensor can include, for example, a laser emitter configured to illuminate a scene and an image sensor configured to capture reflected light from such illumination. The ToF sensor can further include a controller configured to determine a depth measurement for each captured reflection according to the time difference between illumination pulses and reflections. The depth measurement indicates the distance between the sensor 132 itself and the point in space where the reflection originated. Each depth measurement represents a point in a resulting point cloud. The sensor 132 and/or the processor 116 can be configured to convert the depth measurements into points in a three-dimensional coordinate system.

The sensor 132 can also be configured to capture ambient light. For example, certain ToF sensors employ infrared laser emitters alongside infrared-sensitive image sensors. Such a ToF sensor is therefore capable of both generating a point cloud based on reflected light emitted by the laser emitter, and an image corresponding to both reflected light from the emitter and reflected ambient light. The capture of ambient light can enable the ToF sensor to produce an image with a greater resolution than the point cloud, albeit without associated depth measurements. In further examples, the two-dimensional image can have the same resolution as the point cloud. For example, each pixel of the image can include an intensity measurement (e.g., forming the two-dimensional image), and zero or one depth measurements (the set of the depth measurements defining the point cloud). The sensor 132 and/or the processor 116 can, however, map points in the point cloud to pixels in the image, and three-dimensional positions for at least some pixels can therefore be determined from the point cloud.

In other examples, the sensor assembly 132 can include various other sensing hardware, such as a ToF sensor and an independent color camera. In further examples, the sensor assembly 132 can include a depth sensor other than a ToF sensor, such as a stereo camera, or the like.

The memory 120 stores computer readable instructions for execution by the processor 116. In particular, the memory 120 stores a dimensioning application 136 which, when executed by the processor 116, configures the processor 116 to process point cloud data captured via the sensor assembly 132 to detect the object 104 and determine dimensions (e.g., the width, depth, and height shown in FIG. 1) of the object 104. For example, the dimensioning process implemented by the application 136 can include identifying an upper surface 138 of the object 104, and the support surface 108, in the point cloud. The height H of the object 104 can be determined as the distance between the upper surface 138 and the support surface 108 (e.g., the perpendicular distance between the surfaces 138 and 108). The width W and the depth D can be determined as the dimensions of the upper surface 138.

Under some conditions, the point cloud captured by the sensor assembly 132 can contain artifacts that impede the determination of accurate dimensions of the object 104. For example, dark-colored surfaces on the object 104 may absorb light emitted by a ToF sensor and thereby reduce the quantity of reflections detected by the sensor 132. In other examples, surfaces of the object 104 that are not perpendicular to an optical axis of the sensor 132 may result in fewer reflections being detected by the sensor. This effect may be more pronounced the more angled a surface is relative to the optical axis (e.g., the further the surface is from being perpendicular to the optical axis). For example, a point 140-1 on an upper surface of the object 104 may be closer to perpendicular to the optical axis and therefore more likely to generate reflections detectable by the sensor 132, while a point 140-2 may lie on a surface at a less perpendicular angle relative to the optical axis of the sensor 132. The point 140-2 may therefore be less likely to be represented in a point cloud captured by the sensor 132.

Still further, increased distance between the sensor 132 and portions of the object 104 may result in the collection of fewer reflections by the sensor 132. The point 140-2 may therefore also be susceptible to underrepresentation in a captured point cloud due to increased distance from the sensor 132, e.g., if the object is sufficiently large (e.g., with a depth D greater than about 1.5 m in some examples). Other points, such as a point 140-3, may also be vulnerable to multipath artifacts, in which light emitted from the sensor 132 impacts the point 140-3 and reflects onto the support surface 108 before returning to the sensor 132, therefore inflating the perceived distance from the sensor 132 to the point 140-3.

In other words, factors such as the angle of a given surface relative to the sensor 132, the distance from the sensor 132 to the surface, the color of the surface, and the reflectivity of the surface, can negatively affect the density of a point cloud depicting that surface. Other examples of environmental factors impacting point cloud density include the presence of bright ambient light, e.g., sunlight, which may heat the surface of the object 104 and result in artifacts when infrared-based sensing is employed.

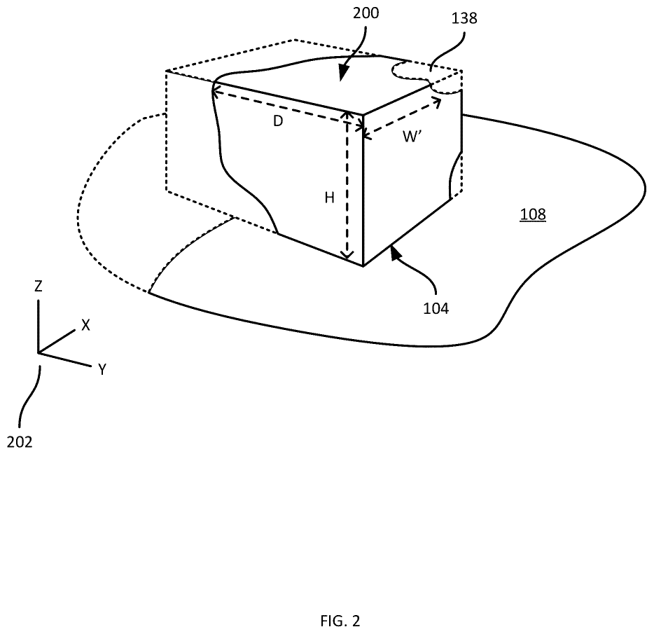

Factors such as those mentioned above can lead to reduced point cloud density corresponding to some regions of the object 104, and/or other artifacts in a captured point cloud. Turning to FIG. 2, an example point cloud 200 is illustrated, as captured by the sensor 132. The portions of the object 104 and the support surface 108 shown in solid lines are represented in the point cloud 200, e.g., as points in a coordinate system 202, while the portions of the object 104 and the support surface 108 shown in dashed lines are not represented in the point cloud 200. That is, certain portions of the object 104 are not depicted in the point cloud 200 due to the artifacts mentioned above. The example shown in FIG. 2 is exaggerated for illustration, and it will be understood that in practice the point cloud 200 may include points in the regions illustrated as being empty, although the number and/or accuracy of those points may be suboptimal.

As will be understood from FIG. 2, it may be possible to derive the height H of the object 104 from the point cloud 200, but the width W and the depth D may not be accurately derivable. For example, from the point cloud 200 a width W′ and a depth D′ may be determined, based on the incomplete representation of the upper surface 138 in the point cloud 200. The width W′ and the depth D′, as will be apparent from FIGS. 1 and 2, do not accurately reflect the true width W and depth D of the object 104.

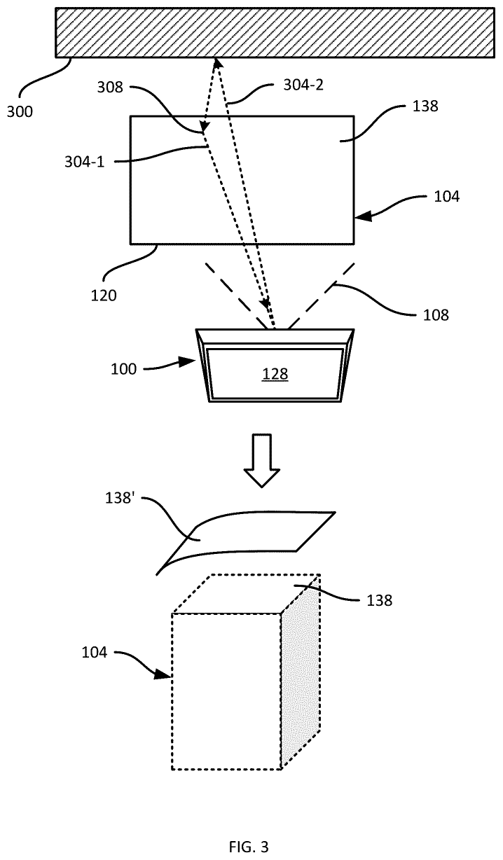

In other examples, artifacts near the vertices of the object 104 may also impede successful dimensioning of the object 104. For example, referring to FIG. 3, an overhead view of the device 100 and the object 104 is shown, in which the object 104 is adjacent to another surface 300, such as a wall, another parcel, or the like. Following emission of a pulse of illumination, a single pixel of the sensor 132 may receive two distinct reflections 304-1 and 304-2. The reflection 304-1 may arrive at the sensor 132 directly from a point 308 on the upper surface 138. The reflection 304-2 may arrive at the sensor 132 having first reflected from the first point 308 to the surface 300.

The sensor 132 can integrate the various reflections 304 to generate a depth measurement corresponding to the point 308. Due to the variable nature of multipath reflections, however, it may be difficult to accurately determine the position of the point 308 in three-dimensional space. For example, the sensor may overestimate the distance between the sensor and the point 308. The resulting point cloud, for instance, may depict an upper surface 138′ that is distorted relative to the true shape of the upper surface 138 (the object 104 is shown in dashed lines below the surface 138′ for comparison). The surface 138′, in this exaggerated example, has a curved profile and is larger in one dimension than the true surface 112. Multipath artifacts in captured point clouds may therefore lead to inaccurate dimensions for the object 104.

The above obstacles to accurate dimensioning can impose limitations of various dimensioning applications, e.g., necessitating sensor data capture from a constrained top-down position rather than the more flexible isometric position shown in FIG. 1 (in which three faces of the object 104 are presented to the sensor 132). Further limitations can include restrictions on dimensioning larger objects, dark-colored objects, and the like. In some examples, multiple captures may be required to accurately obtain dimensions for the object 104, thus consuming more time for dimensioning than a single capture.

To mitigate the above obstacles to point cloud capture and downstream activities such as object dimensioning, execution of the application 136 also configures the processor 116 to use both the point cloud and the image captured by the sensor 132 to segment the upper surface 138 (that is, to determine the three dimensional boundary of the upper surface 138). The use of image data alongside the point cloud can facilitate a more accurate detection of the boundary of the upper surface 138, and can lead to more accurate dimensioning of the object 104. In addition, execution of the application 136 can configure the processor 116 to assess the point cloud for multipath-induced artifacts, and to notify the operator of the device 100 when such artifacts are present.

In other examples, the application 144 can be implemented within the sensor assembly 132 itself (which can include a dedicated controller or other suitable processing hardware). In further examples, either or both of the applications 136 and 144 can be implemented by one or more specially designed hardware and firmware components, such as FPGAs, ASICs and the like.

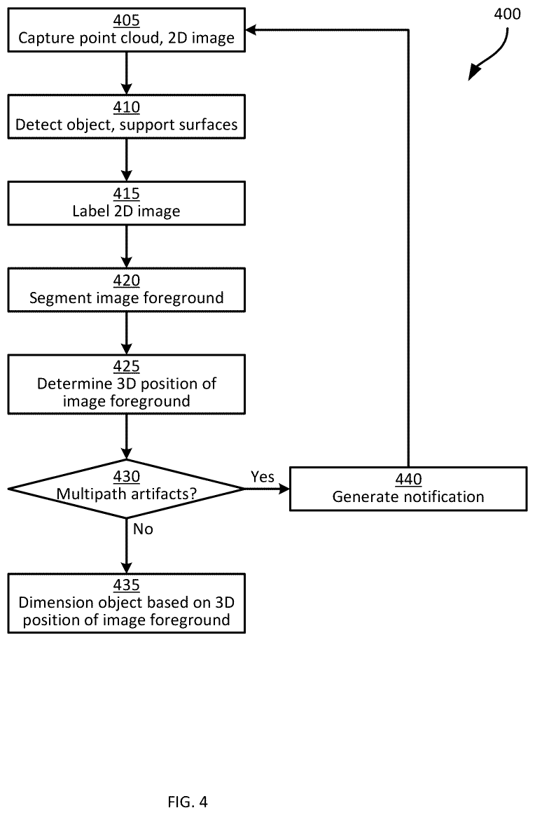

Turning to FIG. 4, a method 400 of image-assisted object surface segmentation is illustrated. The method 400 is described below in conjunction with its performance by the device 100, e.g., to dimension the object 104. It will be understood from the discussion below that the method 400 can also be performed by a wide variety of other computing devices including or connected with sensor assemblies functionally similar to the sensor assembly 132.

At block 405, the device 100 is configured, e.g., via control of the sensor 132 by the processor 116, to capture a point cloud depicting at least a portion of the object 104, and a two-dimensional image depicting at least a portion of the object 104. The device 100 can, for example, be positioned relative to the object 104 as shown in FIG. 1, to capture a point cloud and image depicting the upper surface 138 and one or more other surfaces of the object 104. The image is captured substantially simultaneously with the point cloud, e.g., by the same sensor 132 in the case of a ToF sensor assembly, and/or by an independent color or greyscale camera that is synchronized with the depth sensor.

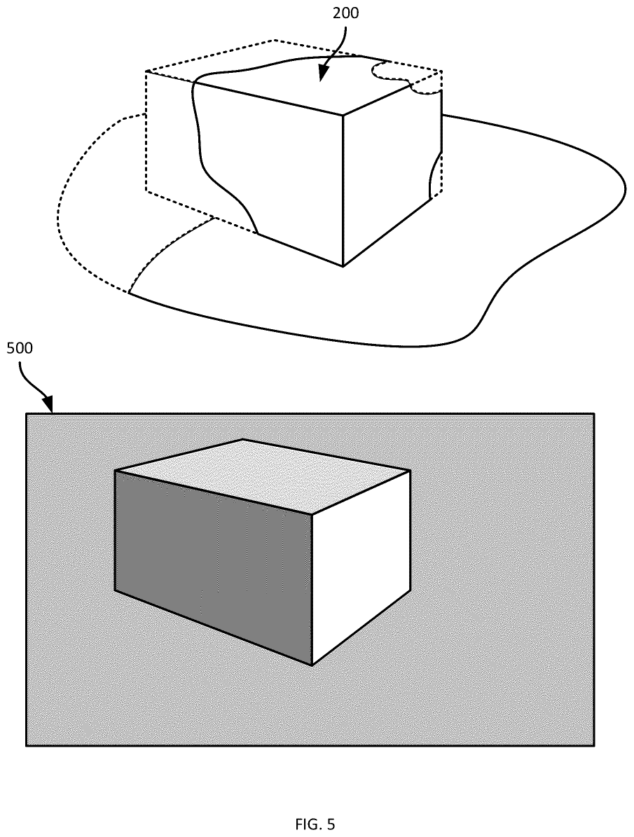

FIG. 5 illustrates an example point cloud 200 (as illustrated in FIG. 2) and an example image 500 captured at block 405. The image 500 is, in this example, a greyscale image captured by the infrared-sensitive ToF sensor 132, simultaneously with the capture of the point cloud 200. The image 500 therefore includes a two-dimensional array of pixels, each including a value indicating a brightness or the like. In other examples, the image can include color data (e.g., red, green, and blue values for each pixel). As shown in FIG. 5, while the point cloud 200 provides an incomplete depiction of the visible surfaces of the object 104, the image 500 is less likely to include discontinuities or other artifacts, due to the increased light level available for image capture relative to depth capture.

Returning to FIG. 4, at block 410 the device 100 is configured to detect the support surface 108 and at least one surface of the object 104, from the point cloud 200. In the present example, the device 100 is configured to detect the upper surface 138 and the support surface 108. Detection of surfaces in the point cloud 200 can be performed via a suitable plane-fitting algorithm, such as random sample consensus (RANSAC), or the like. The support surface 108 can be distinguished from other surfaces during such detection by, for example, selecting the detected surface with the lowest height (e.g., the lowest Z value in the coordinate system 202). The upper surface 138 can be distinguished from other surfaces during detection by, for example, selecting a surface substantially parallel to the support surface 108 and/or substantially centered in the point cloud 200. The device 100 can also be configured to detect other surfaces, such as the visible sides of the object 104 between the upper surface 138 and the support surface 108.

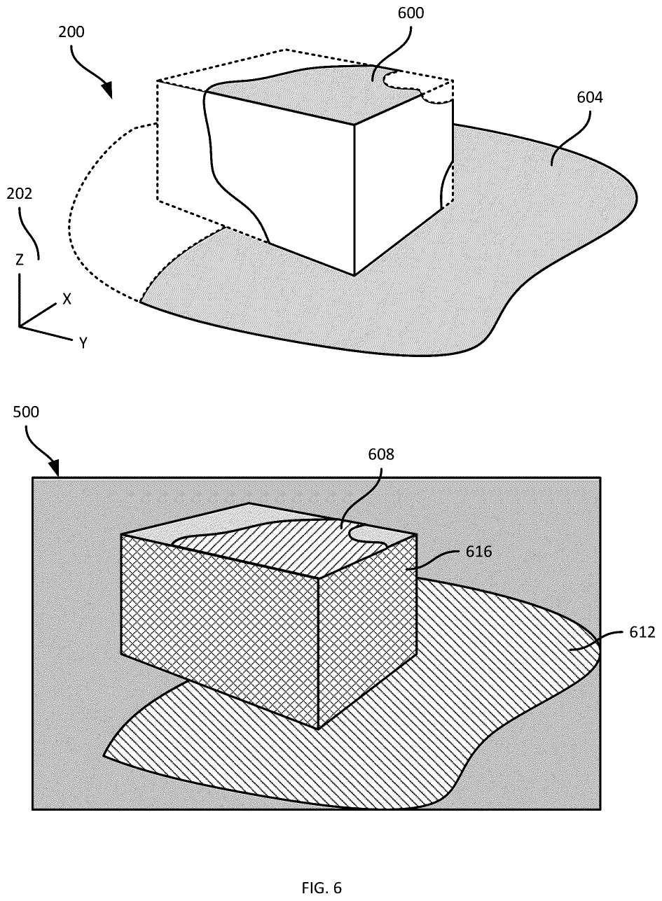

Turning to FIG. 6, the results of an example performance of block 410 are illustrated in the upper portion of FIG. 6. The device 100 has detected a surface 600, corresponding to a portion of the upper surface 138, as well as a surface 604, corresponding to a portion of the support surface 108. As will be apparent from the discussion above, the surface 600 alone may not result in accurate dimensions being determined for the object 104, because the surface 600 does not form a complete representation of the upper surface 138.

Referring again to FIG. 4, at block 415 the device 100 is configured to label at least one region of the image 500, based on the surface detections in the point cloud 200 from block 410. The label(s) applied to the image 500 at block 415 represent an initial segmentation of the image into a foreground, containing the upper surface 138, and a background, containing the remainder of the object 104, the support surface 108, and any other objects surrounding the object 104. The label(s) applied at block 415 need not accurately reflect the boundaries of the upper surface 138. Rather, the label(s) from block 415 serve as inputs to a segmentation algorithm, as discussed below.

At block 415, the device 100 is configured to label a first region of the image 500 corresponding to a portion of the upper surface 138 as a foreground region. In particular, the device 100 is configured to determine the pixel coordinates of the surface 600 in the image 500, based on a mapping between the coordinate system 202 and the pixel coordinates (e.g., represented in calibration data of the sensor 132 or the like). The pixel coordinates corresponding to the surface 600 are then labelled (e.g., in metadata for each pixel, as a set of coordinates defining the region, or the like) as foreground. The lower portion of FIG. 6 illustrates the image 500 with a region 608 labelled as foreground.

The device 100 can also be configured to label additional regions of the image 500. For example, the device 100 can be configured to label a second region 612 of the image 500 as a background region. The second region corresponds to the surface 604 identified from the point cloud 200 at block 410. In further examples, the device 100 can be configured to label a third region 616 of the image 500 as a probable background region, e.g., by identifying surfaces with normal vectors that differ from the normal vector of the surface 600 or 604 by more than a threshold (e.g., by more than about 30 degrees, although various other thresholds can also be employed). The third region 616 can therefore encompass surfaces such as the sides of the object 104, as shown in FIG. 6, as well as walls or other substantially vertical surfaces behind or beside the object 104. In still further examples, the device 100 can label a remainder of the image 500 (that is, any pixels not already encompassed by one of the regions 608, 612, and 616) as a probable foreground region.

Returning to FIG. 4, at block 420 the device 100 is configured to segment an image foreground from the image 500, based on the label(s) applied at block 415. Segmentation at block 420 can include implementing a graph cut-based algorithm, such as GrabCut (e.g., as implemented in the OpenCV library, or any other suitable machine vision library). As will be apparent to those skilled in the art, the GrabCut operation builds a graph of the image 500, with each pixel represented by a node in the graph, connected with neighboring pixels by edges. Each node is also connected to a source node (corresponding to foreground) and a sink node (corresponding to background). The links between nodes are weighted, indicating strengths of connections between nodes. The initial weights are set based on the labels assigned at block 415. The graph is then segmented to minimize a cost function that seeks to group pixels of similar intensity or other properties. The above process can be iterated, e.g., by determining updated weights based on the initial segmentation, and repeating the segmentation until convergence.

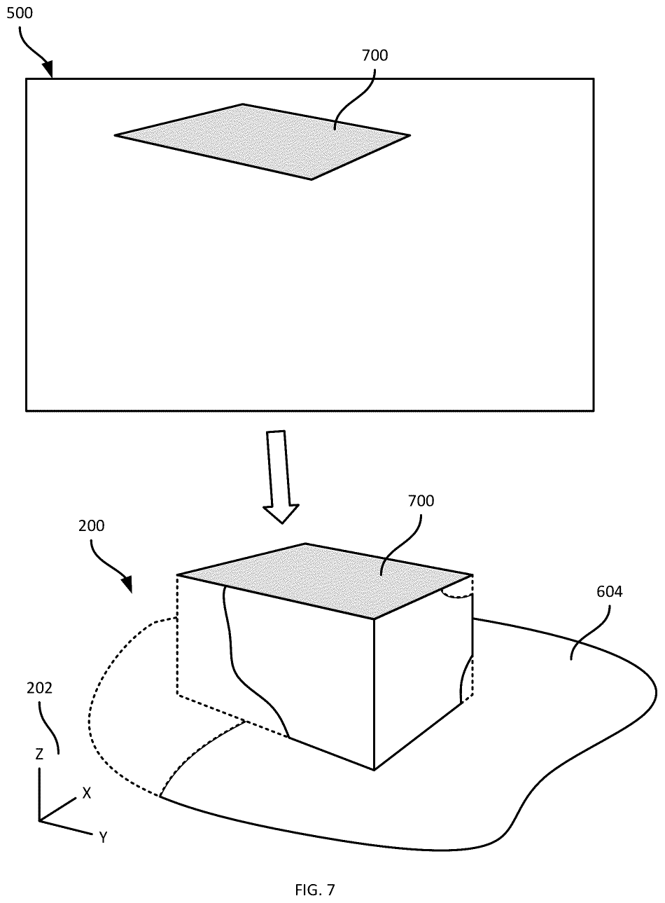

The output of block 420, turning to FIG. 7, is a boundary 700 in the pixel coordinates of the image 500, corresponding to the upper surface 138. In other words, using the regions labelled at block 415 (and derived from the point cloud 200) as inputs to an image-based segmentation mechanism enables the device 100 to leverage both the point cloud 200 and the image 500 to accurately detect the upper surface 138. At block 425, the device 100 is configured to map the boundary 700 into the coordinate system 202. The device 100 can then be configured, at block 435, to use the mapped region 700 to determine dimensions (e.g., the width W and depth D) of the object 104. As noted earlier, the height H of the object 104 can be determined based on the upper surface 138 and the support surface 108. The dimensions can be presented on the display 128, transmitted to another computing device, or the like.

In some examples, prior to determining dimensions of the object 104 at block 435, the device 100 can assess the point cloud 200 for multipath artifacts, at block 430. When the determination at block 430 is negative, the device 100 can proceed to block 435. When the determination at block 430 is affirmative, however, the device 100 can instead proceed to block 440, at which the device 100 can generate a notification, e.g., a warning on the display 128, an audible tone, or the like. The notification can indicate to an operator of the device 100 that the object and/or device 100 should be repositioned, e.g., to move the object 104 away from other nearby objects, to increase dimensioning accuracy.

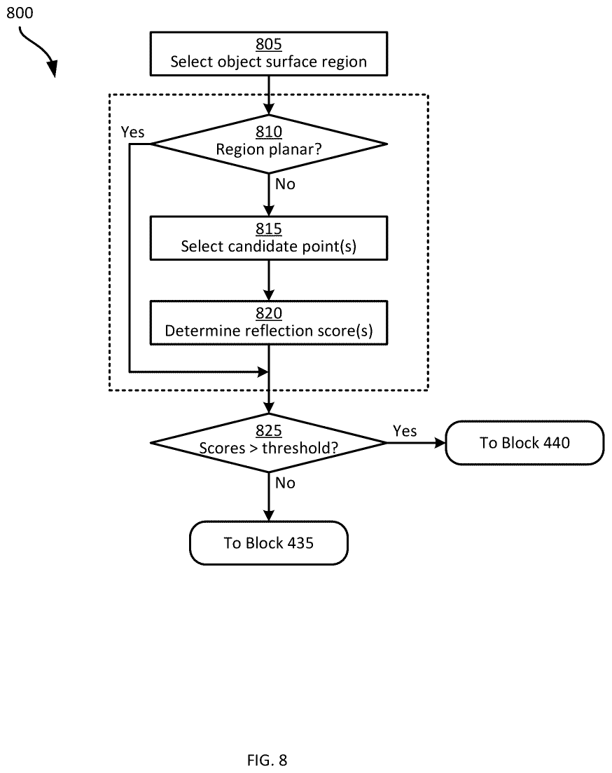

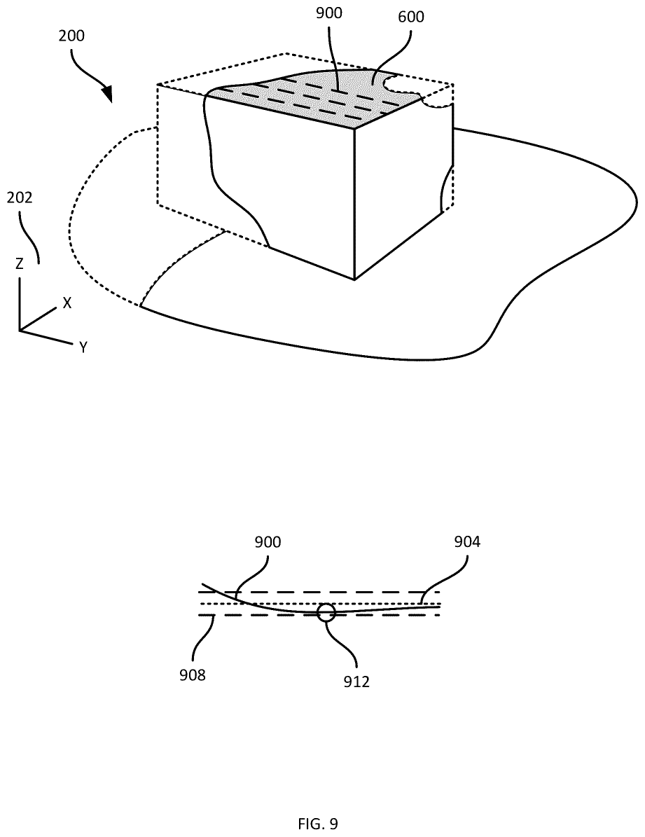

The determination at block 430 can be performed by evaluating certain regions of the surface 600 detected in the point cloud 200 at block 410. Turning to FIG. 8, a method 800 of detecting multipath artifacts is illustrated, which may be performed by the device 100 to implement block 430 of the method 400. At block 805, the device 100 is configured to select a region of the surface 600 corresponding to the upper surface 138. The device 100 can apply a line mask or other subsampling mask to the point cloud 200, as illustrated in FIG. 9. As shown in FIG. 9, each line 900 constitutes a region of the surface 600. The device 100 can therefore select the points of the point cloud 200 along a line 900 for further processing. In other examples, the subsampling mask applied to the point cloud 200 can include a radial mask, e.g., with lines 900 radiating outwards from a center of the surface 600.

At block 810, the device 100 can be configured to determine whether the region is planar. For example, as shown in FIG. 9, the device 100 can determine whether any of the points on a selected line 900 deviate from a plane 904 fitted to the surface 600 by more than a threshold distance 908. When the determination is negative, the device 100 can proceed to the next region (e.g., the next line 900). When the determination is affirmative (as in the example of FIG. 9), the device 100 is configured, at block 815, to select one or more candidate points for assessment. The candidate points can be, for example, the point with the lowest Z value in the coordinate system 202, the point with the highest Z value, or both. A candidate point 912 is shown in FIG. 9. That is, the candidate points can be selected from a non-planar portion of the surface 600. In other examples, however, the candidate points can be selected from planar portions of the surface 600. For example, a set of candidate points can be selected at a predetermined spacing along the line 900.

At block 820, the device 100 is configured to determine one or more reflection scores for the candidate point(s) from block 815. For example, the device 100 can determine a first score indicating the likelihood and/or intensity of a specular reflection arriving at the sensor 132 via the candidate point, from a contributing point such as a surface of a different object in the sensor 132 field of view. The device 100 can also determine a second score indicating the likelihood and/or intensity of a diffuse reflection arriving at the sensor 132 via the candidate point, from the contributing point.

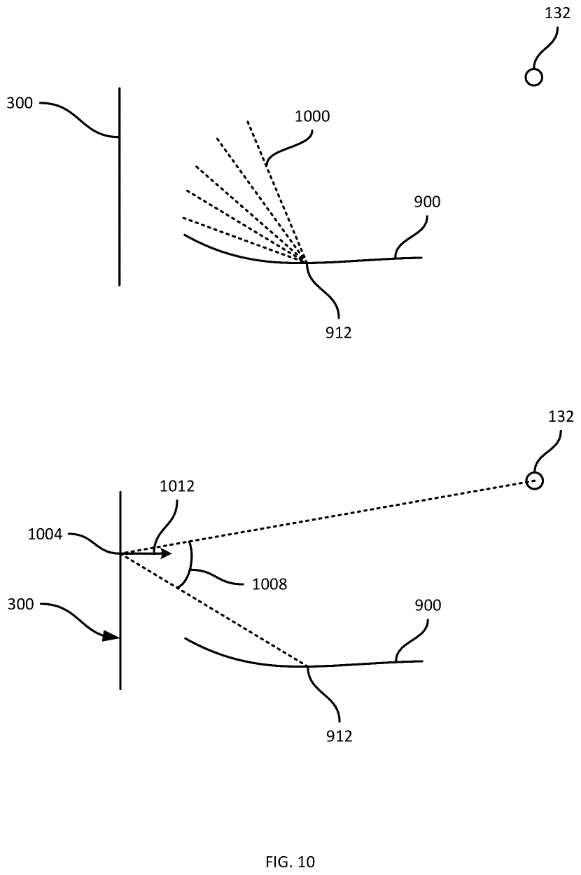

To determine the score(s) at block 820, turning to FIG. 10, the device 100 is configured to generate a plurality of rays 1000 originating at the candidate point 912 and extending away from the sensor 132. The rays can be generated, for example, in a hemispherical area originating at the candidate point 912. For each ray 1000, the device 100 is configured to determine whether the ray 1000 intersects another point in the point cloud 200, such as a point defining the previously mentioned surface 300 (e.g., a wall behind the object 104). When the ray 1000 does not intersect another point, the next ray 1000 is evaluated. When the ray 1000 does intersect another point, such as a point 1004 shown in FIG. 10, the device 100 is configured to determine an angle 1008 between the location of the sensor 132, the point 1004, and the candidate point 912. A first score can be assigned to the candidate point 912 if a normal vector 1012 at the contributing point 1004 bisects the angle 1008. As seen in FIG. 10, the normal 1012 does not bisect the angle 1008, and the candidate point 912 is therefore unlikely to have resulted in a specular reflection from the contributing point 1004 and causing multipath interference. When the angle is bisected by the normal vector of the contributing point, the score associated with the candidate point 912 can be incremented, set to a binary value indicating likely multipath interference, or the like.

The device 100 can also evaluate the candidate point 912 and the contributing point 1004 for diffuse reflections, which are proportional to the cosine of the angle 1008. That is, the smaller the angle 1008, the greater an intensity of a diffuse reflection, and the higher the diffuse reflection score associated with the candidate point 912. The evaluation of the likelihood of specular and/or diffuse reflections can each be based on, for example, a nominal reflectivity index, as the specific reflectivity of different target objects may vary.

The above process is repeated for each ray, for each candidate point, and for each region such as the lines 900. Returning to FIG. 8, at block 825 the device 100 is configured to determine whether the combined scores of the candidate points evaluated via blocks 815 and 820 are above a threshold. For example, the device 100 can sum all of the diffuse scores from the candidate points, and can sum all of the specular scores from the candidate points, and compare the two sums to respective thresholds (e.g., set empirically). When the determination at block 825 is affirmative (e.g., for either or both of the specular score sum and the diffuse score sum), the device 100 can proceed to block 440. Otherwise, the device 100 can proceed to block 435. In other examples, the determination at block 825 can include evaluating the combined score of each individual point from block 820 against a threshold. If the score of any individual point exceeds the threshold, the determination at block 825 is affirmative.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
capturing, via a depth sensor, (i) a point cloud depicting an object resting on a support surface, and (ii) a two-dimensional image depicting the object and the support surface;
detecting, from the point cloud, the support surface and a portion of an upper surface of the object;
labelling a first region of the image corresponding to the portion of the upper surface as a foreground region;
based on the first region, performing a foreground segmentation operation on the image to segment the upper surface of the object from the image;
determining, based on the point cloud, a three-dimensional position of the upper surface segmented from the image; and
determining dimensions of the object based on the three-dimensional position of the upper surface.

2. The method of claim 1, further comprising: presenting the dimensions on a display of the computing device.

3. The method of claim 1, further comprising: labelling a second region of the image corresponding to the support surface as a background region.

4. The method of claim 3, further comprising:
detecting, in the point cloud, a further surface distinct from the upper surface and the support surface; and
labelling a third region of the image corresponding to the further surface as a probably background region.

5. The method of claim 4, wherein detecting the further surface includes detecting a portion of the point cloud with a normal vector different from a normal vector of the upper surface by at least a threshold.

6. The method of claim 4, further comprising: labelling a remainder of the image as a probable foreground region.

7. The method of claim 1, further comprising:
prior to determining dimensions of the object, determining whether the point cloud exhibits multipath artifacts by:
selecting a candidate point on the upper surface;
determining a reflection score for the candidate point; and
comparing the reflection score to a threshold.

8. The method of claim 7, wherein selecting the candidate point includes identifying a non-planar region of the upper surface, and selecting the candidate point from the non-planar region.

9. The method of claim 7, wherein determining a reflection score includes:
for each of a plurality of rays originating at the candidate point, determining whether the point cloud contains a contributing point intersected by the ray;
for each contributing point, determining an angle between the depth sensor, the contributing point, and the candidate point; and
when a normal of the contributing point bisects the angle, incrementing the reflection score.

10. The method of claim 9, wherein determining a reflection score includes incrementing the reflection score based proportionally to a cosine of the angle.

11. A computing device, comprising:
a depth sensor; and
a processor configured to:
capture, via the depth sensor, (i) a point cloud depicting an object resting on a support surface, and (ii) a two-dimensional image depicting the object and the support surface;
detect, from the point cloud, the support surface and a portion of an upper surface of the object;
label a first region of the image corresponding to the portion of the upper surface as a foreground region;
based on the first region, perform a foreground segmentation operation on the image to segment the upper surface of the object from the image;
determine, based on the point cloud, a three-dimensional position of the upper surface segmented from the image; and
determine dimensions of the object based on the three-dimensional position of the upper surface.

12. The computing device of claim 11, wherein the processor is further configured to present the dimensions on a display.

13. The computing device of claim 11, wherein the processor is further configured to: label a second region of the image corresponding to the support surface as a background region.

14. The computing device of claim 13, wherein the processor is further configured to:
detect, in the point cloud, a further surface distinct from the upper surface and the support surface; and
label a third region of the image corresponding to the further surface as a probably background region.

15. The computing device of claim 14, wherein the processor is further configured to detect the further surface by: detecting a portion of the point cloud with a normal vector different from a normal vector of the upper surface by at least a threshold.

16. The computing device of claim 14, wherein the processor is further configured to: label a remainder of the image as a probable foreground region.

17. The computing device of claim 11, wherein the processor is further configured to:
prior to determining dimensions of the object, determine whether the point cloud exhibits multipath artifacts by:
selecting a candidate point on the upper surface;
determining a reflection score for the candidate point; and
comparing the reflection score to a threshold.

18. The computing device of claim 17, wherein the processor is further configured to select the candidate point by identifying a non-planar region of the upper surface, and selecting the candidate point from the non-planar region.

19. The computing device of claim 17, wherein the processor is further configured to determine a reflection score by:
for each of a plurality of rays originating at the candidate point, determining whether the point cloud contains a contributing point intersected by the ray;
for each contributing point, determining an angle between the depth sensor, the contributing point, and the candidate point; and
when a normal of the contributing point bisects the angle, incrementing the reflection score.

20. The computing device of claim 19, wherein the processor is further configured to determine a reflection score by incrementing the reflection score based proportionally to a cosine of the angle.
